(19) United States
(12) Patent Application Publication
(10) Pub. No.: US 2026/0113398 A1
(43) Pub. Date: Apr. 23, 2026

(54) SYSTEM

(71) Applicant: SoftBank Group Corp., Tokyo (JP)

(72) Inventor: Tetsu SHIBUTANI, Tokyo (JP)

(21) Appl. No.: 19/354,282

(22) Filed: Oct. 9, 2025

(30) Foreign Application Priority Data
Oct. 18, 2024 (JP) 2024-183992

(51) Int. Cl. H04M 1/66; G10L 15/26; G10L 25/63

(52) U.S. Cl. CPC H04M 1/66; G10L 15/26; G10L 25/63; H04M 2201/40

(57) ABSTRACT

The system according to the embodiment includes an analysis unit, a determination unit, and a ringing unit.

The analysis unit analyzes the content of a telephone call. The determination unit determines, based on the content analyzed by the analysis unit, whether the call is a safe call. The ringing unit sounds a ringtone when the determination unit determines that the call is a safe call.

### CROSS-REFERENCE TO RELATED APPLICATION

The present application claims priority to and incorporates by reference the entire contents of Japanese Patent Application No. 2024-183992 filed in Japan on Oct. 18, 2024.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, including: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that elderly people are defenseless against fraudulent calls and it is difficult to receive only safe calls.

### SUMMARY OF THE INVENTION

The system according to the embodiment includes an analysis unit, a determination unit, and a ringing unit. The analysis unit analyzes the content of a telephone call. The determination unit determines, based on the content analyzed by the analysis unit, whether the call is a safe call. The ringing unit sounds a ringtone when the determination unit determines that the call is a safe call.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor with a sign (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) with a sign is a memory where information is temporarily stored and used as a work memory by the processor.

In the following embodiments, a storage with a sign is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) with a sign is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,”the same concept as “A and/or B”applies. First Embodiment

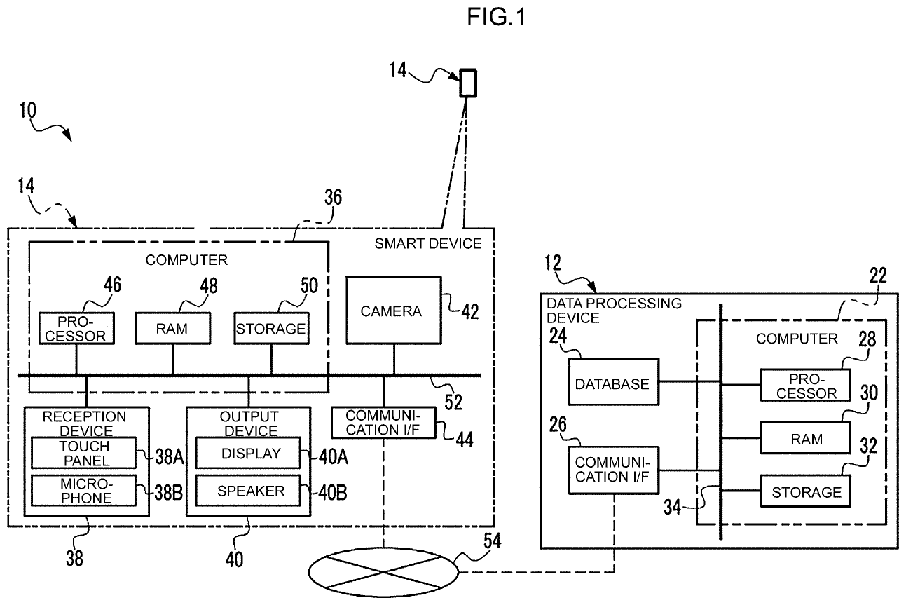

FIG. 1 shows an example configuration of a data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52.

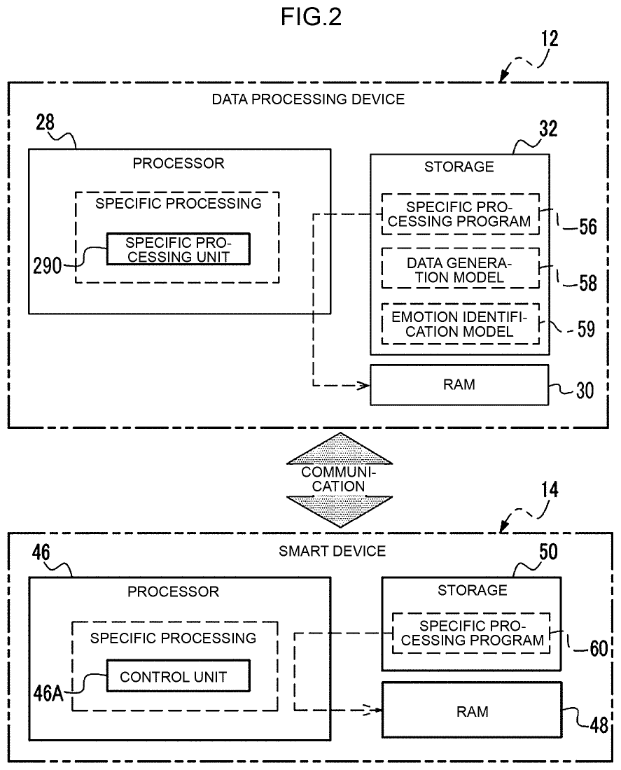

The reception device 38 includes a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 includes a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1 of Embodiment

The telephone call receiving system according to the embodiment of the present invention is a system that allows only safe calls to be received at the homes of elderly people by using AI. When a call is received, the telephone call receiving system uses AI to analyze the content of the call and determine whether it is a safe call. Next, only when it is determined to be a safe call, the ringtone is sounded. As a result, elderly people can receive calls with peace of mind. For example, when a call is received, the AI converts the content of the call into text using speech recognition technology. For example, calls containing “keywords indicative of possible fraud” are determined to be unsafe. This reduces the risk of fraud. Next, the AI analyzes the content of the call and determines whether it is a safe call. For example, calls from family members or friends are determined to be safe, while calls from unknown numbers or calls containing keywords indicative of possible fraud are determined to be unsafe. As a result, elderly people can receive calls with peace of mind. Furthermore, only when it is determined to be a safe call, the ringtone is sounded. As a result, elderly people can receive calls with peace of mind. For example, only when a call is received from a family member or friend, the ringtone is sounded, and elderly people can receive calls with peace of mind. With this mechanism, elderly people can receive calls with peace of mind. It is possible to reduce the risk of fraud and realize a situation in which only safe calls are received. For example, the “risk of fraud” can be reduced, and elderly people can receive calls with peace of mind. In addition, since only calls from family members or friends are received, elderly people can receive calls with peace of mind. As a result, the telephone call receiving system allows elderly people to receive calls with peace of mind.

The telephone call receiving system according to the embodiment includes an analysis unit, a determination unit, and a ringing unit. The analysis unit analyzes the content of a telephone call. The analysis unit, for example, converts the content of the telephone call into text using speech recognition technology. The analysis unit can convert the content of the telephone call into text with high accuracy by using deep learning-based speech recognition technology. The analysis unit can also convert the content of the telephone call into text using HMM-based speech recognition technology. The analysis unit can convert the content of the telephone call into text in real time using speech recognition technology. The determination unit determines, based on the content analyzed by the analysis unit, whether the call is a safe call. The determination unit, for example, determines that calls from family members or friends are safe. The determination unit can determine that calls from persons registered in the contact list are safe. The determination unit can also determine that calls from specific phone numbers are safe. The determination unit can preferentially determine that calls from family members or friends are safe. The determination unit determines that calls containing keywords indicative of possible fraud are not safe. The determination unit can determine that calls containing keywords such as “money,” “transfer,” or “emergency” are not safe. The determination unit can also refer to the latest information on fraud schemes to update the keywords indicative of possible fraud. The determination unit can automatically extract keywords indicative of possible fraud and determine that such calls are not safe. The ringing unit sounds a ringtone when the determination unit determines that the call is a safe call. The ringing unit can sound a ringtone only when the call is a safe call. The ringing unit can sound a ringtone only when a call is received from a family member or friend. The ringing unit can also sound a ringtone only when a call is received from a specific phone number. The ringing unit can sound a specific ringtone when it is determined to be a safe call. As a result, the telephone call receiving system according to the embodiment allows elderly people to receive calls with peace of mind.

The analysis unit analyzes the content of a telephone call. The analysis unit, for example, converts the content of the telephone call into text using speech recognition technology. Specifically, by using deep learning-based speech recognition technology, the content of the telephone call can be converted into text with high accuracy. Deep learning technology can accurately capture the characteristics of speech by learning from a large amount of voice data, making it possible to recognize speech accurately even in noisy environments. HMM (Hidden Markov Model)-based speech recognition technology can also be used. HMM can efficiently analyze continuous speech data by modeling the temporal changes in speech. By combining these technologies, the analysis unit can convert the content of the telephone call into text in real time. Furthermore, the analysis unit can analyze the meaning of the text using natural language processing technology in addition to speech recognition technology. For example, important keywords can be extracted from the text and the content of the call can be summarized. As a result, the analysis unit can analyze the content of the call in detail and generate highly accurate data to be provided to the determination unit.

The determination unit determines, based on the content analyzed by the analysis unit, whether the call is a safe call. The determination unit, for example, determines that calls from family members or friends are safe. Specifically, the determination unit can determine that calls from persons registered in the contact list are safe. The contact list is a database including phone numbers and names registered by the user in advance, and the determination unit checks the caller by referring to this list. The determination unit can also determine that calls from specific phone numbers are safe. For example, by registering phone numbers of reliable institutions such as banks or medical institutions in advance, these calls can be determined to be safe. Furthermore, the determination unit determines that calls containing keywords indicative of possible fraud are not safe. For example, the determination unit can determine that calls containing keywords such as “money,” “transfer,” or “emergency” are not safe. The determination unit can refer to the latest information on fraud schemes to update the keywords indicative of possible fraud. As a result, the determination unit can always determine safety based on the latest fraud information. The determination unit can also use AI to analyze the content of the call and automatically extract keywords indicative of possible fraud. By learning from past fraudulent call data, AI can recognize fraud patterns and respond to new fraud schemes. As a result, the determination unit can determine safety with high accuracy and provide an environment where users can receive calls with peace of mind.

The ringing unit sounds a ringtone when the determination unit determines that the call is a safe call. Specifically, the ringtone can be sounded only when the call is a safe call. For example, the ringtone can be sounded only when a call is received from a family member or friend. The ringing unit can also sound a ringtone only when a call is received from a specific phone number. As a result, the user can receive important calls without missing them. Furthermore, the ringing unit can sound a specific ringtone when it is determined to be a safe call. For example, a specific melody can be set for calls from family members, and a different melody can be set for calls from friends, allowing the user to intuitively identify the caller. Furthermore, the ringing unit can customize the ringtone according to the user's preferences. For example, a quiet ringtone can be set during certain time periods, and a loud notification can be provided in emergencies. As a result, the ringing unit can provide flexible notification methods tailored to the user's lifestyle. Furthermore, the ringing unit can use not only ringtones but also notifications such as vibration or flashing lights. This allows the system to accommodate users with hearing impairments or those who need to receive calls in quiet environments. As a result, the telephone call receiving system according to the embodiment can not only allow elderly people to receive calls with peace of mind but also accommodate various user needs.

The analysis unit can convert the content of a telephone call into text using speech recognition technology. The analysis unit can, for example, convert the content of the telephone call into text with high accuracy using deep learning-based speech recognition technology. The analysis unit can also convert the content of the telephone call into text using HMM-based speech recognition technology. The analysis unit can, for example, convert the content of the telephone call into text in real time using speech recognition technology. As a result, converting the content of the call into text improves the accuracy of analysis. Speech recognition technology includes, for example, deep learning-based speech recognition technology and HMM-based speech recognition technology, but is not limited to these examples. Some or all of the above-described processing in the analysis unit may be performed using generative AI, or may be performed without using generative AI. For example, the analysis unit can input the voice data of the call to generative AI and have the generative AI perform the conversion from voice data to text data.

The determination unit can determine that calls from family members or friends are safe. The determination unit can, for example, determine that calls from persons registered in the contact list are safe. The determination unit can also determine that calls from specific phone numbers are safe. The determination unit can preferentially determine that calls from family members or friends are safe. As a result, by determining that calls from family members or friends are safe, elderly people can receive calls with peace of mind. Family members or friends include, for example, persons registered in the contact list or calls from specific phone numbers, but are not limited to these examples. Some or all of the above-described processing in the determination unit may be performed using generative AI, or may be performed without using generative AI. For example, the determination unit can input caller information to generative AI and have the generative AI determine whether the call is a safe call based on the caller information.

The determination unit can determine that calls containing keywords indicative of possible fraud are not safe. The determination unit can, for example, determine that calls containing keywords such as “money,” “transfer,” or “emergency” are not safe. The determination unit can refer to the latest information on fraud schemes to update the keywords indicative of possible fraud. The determination unit can automatically extract keywords indicative of possible fraud and determine that such calls are not safe. As a result, the risk of fraud can be reduced. Keywords indicative of possible fraud include, for example, “money,” “transfer,” “emergency,” and the like, but are not limited to these examples. Some or all of the above-described processing in the determination unit may be performed using generative AI, or may be performed without using generative AI. For example, the determination unit can input the content of the call to generative AI and have the generative AI extract keywords indicative of possible fraud.

The ringing unit can sound a ringtone only when the call is a safe call. The ringing unit can, for example, sound a ringtone only when the call is a safe call. The ringing unit can, for example, sound a ringtone only when a call is received from a family member or friend. The ringing unit can also sound a ringtone only when a call is received from a specific phone number. The ringing unit can, for example, sound a specific ringtone when it is determined to be a safe call. As a result, elderly people can receive calls with peace of mind. Safe calls include, for example, calls from family members or friends or calls from specific phone numbers, but are not limited to these examples. Some or all of the above-described processing in the ringing unit may be performed using generative AI, or may be performed without using generative AI. For example, the ringing unit can input information determined by the determination unit to be a safe call to generative AI and have the generative AI perform the ringing of the ringtone.

The analysis unit can support different languages and dialects when converting the content of a telephone call into text using speech recognition technology. The analysis unit can, for example, have AI automatically detect different languages and select an appropriate speech recognition model to convert the content into text. The analysis unit can, for example, use a dictionary to recognize dialects or region-specific words and convert them into standard language. The analysis unit can, for example, adjust the accuracy of speech recognition and perform text conversion based on the language set by the user. As a result, supporting different languages and dialects improves the accuracy of analysis. Different languages and dialects include, for example, the use of multilingual speech recognition engines or dialect dictionaries, but are not limited to these examples. Some or all of the above-described processing in the analysis unit may be performed using generative AI, or may be performed without using generative AI. For example, the analysis unit can input the voice data of the call to generative AI and have the generative AI perform text conversion corresponding to different languages and dialects.

The analysis unit can remove background sounds and noise when analyzing the content of a telephone call to improve analysis accuracy. The analysis unit can, for example, have AI filter background sounds in real time and extract only the main voice for analysis. The analysis unit can, for example, use noise canceling technology to clarify the content of the call. The analysis unit can, for example, emphasize specific frequency bands and reduce noise to improve the accuracy of speech recognition. As a result, removing background sounds and noise improves the accuracy of analysis. Background sounds and noise include, for example, noise canceling technology and filtering technology, but are not limited to these examples. Some or all of the above-described processing in the analysis unit may be performed using generative AI, or may be performed without using generative AI. For example, the analysis unit can input the voice data of the call to generative AI and have the generative AI perform removal of background sounds and noise.

The analysis unit can highlight specific keywords or phrases when converting the content of a telephone call into text using speech recognition technology. The analysis unit can, for example, automatically detect keywords indicative of possible fraud and highlight them in the text. The analysis unit can, for example, highlight important phrases such as the names of family members or friends. The analysis unit can, for example, highlight specific keywords set by the user. As a result, highlighting specific keywords or phrases makes it less likely that important information will be overlooked. Specific keywords or phrases include, for example, “important,” “emergency,” “confirmation,” and the like, but are not limited to these examples. Some or all of the above-described processing in the analysis unit may be performed using generative AI, or may be performed without using generative AI. For example, the analysis unit can input the voice data of the call to generative AI and have the generative AI perform highlighting of specific keywords or phrases.

The analysis unit can refer to past call history when analyzing the content of a telephone call to improve analysis accuracy. The analysis unit can, for example, analyze past call history to identify frequently used phrases or keywords. The analysis unit can, for example, learn specific patterns from past call history to improve analysis accuracy. The analysis unit can, for example, identify calls with a high likelihood of fraud based on past call history to improve analysis accuracy. As a result, referring to past call history improves the accuracy of analysis. Past call history includes, for example, the retention period of call content and the frequency of reference, but is not limited to these examples. Some or all of the above-described processing in the analysis unit may be performed using generative AI, or may be performed without using generative AI. For example, the analysis unit can input past call history data to generative AI and have the generative AI perform analysis of the call history.

The determination unit can refer to call history and contact lists to improve the accuracy of determining that calls from family members or friends are safe calls. The determination unit can, for example, analyze call history and determine that frequently called parties are safe calls. The determination unit can, for example, refer to the contact list and determine that calls from registered family members or friends are safe. The determination unit can, for example, combine call history and contact lists to improve the accuracy of determination. As a result, referring to call history and contact lists improves the accuracy of determination. Call history and contact lists include, for example, call frequency and contact reliability, but are not limited to these examples. Some or all of the above-described processing in the determination unit may be performed using generative AI, or may be performed without using generative AI. For example, the determination unit can input call history data and contact lists to generative AI and have the generative AI perform analysis of the call history and contact lists.

The determination unit can refer to the latest information on fraud schemes to update the determination criteria when determining that calls containing keywords indicative of possible fraud are not safe calls. The determination unit can, for example, periodically update the latest information on fraud schemes and reflect it in the determination criteria. The determination unit can, for example, automatically update the list of keywords indicative of possible fraud and incorporate it into the determination criteria. The determination unit can, for example, refer to news and reports on fraud schemes and adjust the determination criteria. As a result, referring to the latest information on fraud schemes keeps the determination criteria up to date. The latest information on fraud schemes includes, for example, police databases and security company reports, but is not limited to these examples. Some or all of the above-described processing in the determination unit may be performed using generative AI, or may be performed without using generative AI. For example, the determination unit can input the latest information on fraud schemes to generative AI and have the generative AI perform updating of the determination criteria.

The determination unit can consider the frequency and time of calls to improve the accuracy of determining that calls from family members or friends are safe calls. The determination unit can, for example, analyze the frequency of calls and determine that frequently called parties are safe calls. The determination unit can, for example, consider the time of calls and determine that calls received during normal hours are safe. The determination unit can, for example, combine the frequency and time of calls to improve the accuracy of determination. As a result, considering the frequency and time of calls improves the accuracy of determination. The frequency and time of calls include, for example, the number of calls and the time of calls, but are not limited to these examples. Some or all of the above-described processing in the determination unit may be performed using generative AI, or may be performed without using generative AI. For example, the determination unit can input call history data to generative AI and have the generative AI perform analysis of the frequency and time of calls.

The determination unit can consider not only the content of the call but also the caller information when determining that calls containing keywords indicative of possible fraud are not safe calls. The determination unit can, for example, analyze the caller's phone number and identify numbers with a high likelihood of fraud. The determination unit can, for example, refer to the caller's regional information and identify calls from regions with a high likelihood of fraud. The determination unit can, for example, combine caller information and call content to improve the accuracy of determination. As a result, considering caller information improves the accuracy of determination. Caller information includes, for example, the caller's phone number and location, but is not limited to these examples. Some or all of the above-described processing in the determination unit may be performed using generative AI, or may be performed without using generative AI. For example, the determination unit can input caller information to generative AI and have the generative AI perform analysis of the caller information.

The ringing unit can adjust the ringing timing by considering the user's schedule and activity status when sounding the ringtone only for safe calls. The ringing unit can, for example, refer to the user's calendar information and not sound the ringtone during important meetings. The ringing unit can, for example, monitor the user's activity status in real time and not sound the ringtone during exercise or sleep. The ringing unit can, for example, sound the ringtone at the optimal timing based on the user's schedule. As a result, the ringtone can be sounded at the optimal timing according to the user's schedule and activity status. The user's schedule and activity status include, for example, calendar apps and activity trackers, but are not limited to these examples. Some or all of the above-described processing in the ringing unit may be performed using generative AI, or may be performed without using generative AI. For example, the ringing unit can input the user's schedule information to generative AI and have the generative AI perform adjustment of the ringing timing.

The ringing unit can provide customizable ringtones according to the user's preferences when sounding the ringtone. The ringing unit can, for example, set music or sound effects selected by the user as the ringtone. The ringing unit can, for example, provide ringtones that reflect the user's customized volume and tone. The ringing unit can, for example, set different ringtones for each specific contact set by the user. As a result, setting ringtones according to the user's preferences provides a more comfortable user experience. User preferences include, for example, user settings and past selection history, but are not limited to these examples. Some or all of the above-described processing in the ringing unit may be performed using generative AI, or may be performed without using generative AI. For example, the ringing unit can input user preference data to generative AI and have the generative AI provide customizable ringtones.

The ringing unit can set the optimal volume by considering the user's device settings and ambient sounds when sounding the ringtone only for safe calls. The ringing unit can, for example, automatically set the appropriate volume based on the user's device settings. The ringing unit can, for example, detect ambient sounds in real time and set the optimal volume. The ringing unit can, for example, customize the volume according to the user's preferences. As a result, setting the optimal volume according to the user's device settings and ambient sounds allows for more appropriate ringtones. The user's device settings and ambient sounds include, for example, device volume settings and surrounding noise levels, but are not limited to these examples. Some or all of the above-described processing in the ringing unit may be performed using generative AI, or may be performed without using generative AI. For example, the ringing unit can input the user's device settings and ambient sound data to generative AI and have the generative AI perform setting of the optimal volume.

The ringing unit can refer to the user's past response history to adjust the ringing pattern when sounding the ringtone. The ringing unit can, for example, analyze the times when the user responded in the past and adjust the ringing pattern to match those times. The ringing unit can, for example, learn the optimal ringing pattern from the user's past response history and apply it. The ringing unit can, for example, set a ringing pattern that makes it easier for the user to respond during specific times. As a result, referring to the user's past response history allows for setting the optimal ringing pattern. The user's past response history includes, for example, response frequency and response times, but are not limited to these examples. Some or all of the above-described processing in the ringing unit may be performed using generative AI, or may be performed without using generative AI. For example, the ringing unit can input the user's past response history data to generative AI and have the generative AI perform adjustment of the ringing pattern.

The system according to the embodiment is not limited to the above-described examples and can be variously modified as follows, for example.

The analysis unit can support different languages and dialects when converting the content of a telephone call into text using speech recognition technology. The analysis unit can, for example, have AI automatically detect different languages and select an appropriate speech recognition model to convert the content into text. The analysis unit can, for example, use a dictionary to recognize dialects or region-specific words and convert them into standard language. The analysis unit can, for example, adjust the accuracy of speech recognition and perform text conversion based on the language set by the user. As a result, supporting different languages and dialects improves the accuracy of analysis. Different languages and dialects include, for example, the use of multilingual speech recognition engines or dialect dictionaries, but are not limited to these examples. Some or all of the above-described processing in the analysis unit may be performed using generative AI, or may be performed without using generative AI. For example, the analysis unit can input the voice data of the call to generative AI and have the generative AI perform text conversion corresponding to different languages and dialects.

The analysis unit can remove background sounds and noise when analyzing the content of a telephone call to improve analysis accuracy. The analysis unit can, for example, have AI filter background sounds in real time and extract only the main voice for analysis. The analysis unit can, for example, use noise canceling technology to clarify the content of the call. The analysis unit can, for example, emphasize specific frequency bands and reduce noise to improve the accuracy of speech recognition. As a result, removing background sounds and noise improves the accuracy of analysis. Background sounds and noise include, for example, noise canceling technology and filtering technology, but are not limited to these examples. Some or all of the above-described processing in the analysis unit may be performed using generative AI, or may be performed without using generative AI. For example, the analysis unit can input the voice data of the call to generative AI and have the generative AI perform removal of background sounds and noise.

The determination unit can refer to the latest information on fraud schemes to update the determination criteria when determining that calls containing keywords indicative of possible fraud are not safe calls. The determination unit can, for example, periodically update the latest information on fraud schemes and reflect it in the determination criteria. The determination unit can, for example, automatically update the list of keywords indicative of possible fraud and incorporate it into the determination criteria. The determination unit can, for example, refer to news and reports on fraud schemes and adjust the determination criteria. As a result, referring to the latest information on fraud schemes keeps the determination criteria up to date. The latest information on fraud schemes includes, for example, police databases and security company reports, but are not limited to these examples. Some or all of the above-described processing in the determination unit may be performed using generative AI, or may be performed without using generative AI. For example, the determination unit can input the latest information on fraud schemes to generative AI and have the generative AI perform updating of the determination criteria.

The ringing unit can adjust the ringing timing by considering the user's schedule and activity status when sounding the ringtone only for safe calls. The ringing unit can, for example, refer to the user's calendar information and not sound the ringtone during important meetings. The ringing unit can, for example, monitor the user's activity status in real time and not sound the ringtone during exercise or sleep. The ringing unit can, for example, sound the ringtone at the optimal timing based on the user's schedule. As a result, the ringtone can be sounded at the optimal timing according to the user's schedule and activity status. The user's schedule and activity status include, for example, calendar apps and activity trackers, but are not limited to these examples. Some or all of the above-described processing in the ringing unit may be performed using generative AI, or may be performed without using generative AI. For example, the ringing unit can input the user's schedule information to generative AI and have the generative AI perform adjustment of the ringing timing.

The analysis unit can refer to past call history when analyzing the content of a telephone call to improve analysis accuracy. The analysis unit can, for example, analyze past call history to identify frequently used phrases or keywords. The analysis unit can, for example, learn specific patterns from past call history to improve analysis accuracy. The analysis unit can, for example, identify calls with a high likelihood of fraud based on past call history to improve analysis accuracy. As a result, referring to past call history improves the accuracy of analysis. Past call history includes, for example, the retention period of call content and the frequency of reference, but is not limited to these examples. Some or all of the above-described processing in the analysis unit may be performed using generative AI, or may be performed without using generative AI. For example, the analysis unit can input past call history data to generative AI and have the generative AI perform analysis of the call history.

The ringing unit can set the optimal volume by considering the user's device settings and ambient sounds when sounding the ringtone only for safe calls. The ringing unit can, for example, automatically set the appropriate volume based on the user's device settings. The ringing unit can, for example, detect ambient sounds in real time and set the optimal volume. The ringing unit can, for example, customize the volume according to the user's preferences. As a result, setting the optimal volume according to the user's device settings and ambient sounds allows for more appropriate ringtones. The user's device settings and ambient sounds include, for example, device volume settings and surrounding noise levels, but are not limited to these examples. Some or all of the above-described processing in the ringing unit may be performed using generative AI, or may be performed without using generative AI. For example, the ringing unit can input the user's device settings and ambient sound data to generative AI and have the generative AI perform setting of the optimal volume.

The following is a brief description of the processing flow of Example 1 of the Embodiment.
Step 1: The analysis unit analyzes the content of a telephone call. The analysis unit converts the content of the telephone call into text using speech recognition technology. For example, deep learning-based speech recognition technology or HMM-based speech recognition technology can be used to convert the content of the telephone call into text with high accuracy and in real time.
Step 2: The determination unit determines, based on the content analyzed by the analysis unit, whether the call is a safe call. The determination unit determines that calls from family members or friends or from persons registered in the contact list are safe. In addition, the determination unit determines that calls containing keywords indicative of possible fraud are not safe and can update the keywords by referring to the latest information on fraud schemes.
Step 3: The ringing unit sounds a ringtone when the determination unit determines that the call is a safe call. For example, the ringtone can be sounded only when a call is received from a family member or friend or from a specific phone number. In addition, a specific ringtone can be sounded when it is determined to be a safe call.

### Example 2 of Embodiment

The telephone call receiving system according to the embodiment of the present invention is a system that allows only safe calls to be received at the homes of elderly people by using AI. When a call is received, the telephone call receiving system uses AI to analyze the content of the call and determine whether it is a safe call. Next, only when it is determined to be a safe call, the ringtone is sounded. As a result, elderly people can receive calls with peace of mind. For example, when a call is received, the AI converts the content of the call into text using speech recognition technology. For example, calls containing “keywords indicative of possible fraud” are determined to be unsafe. This reduces the risk of fraud. Next, the AI analyzes the content of the call and determines whether it is a safe call. For example, calls from family members or friends are determined to be safe, while calls from unknown numbers or calls containing keywords indicative of possible fraud are determined to be unsafe. As a result, elderly people can receive calls with peace of mind. Furthermore, only when it is determined to be a safe call, the ringtone is sounded. As a result, elderly people can receive calls with peace of mind. For example, only when a call is received from a family member or friend, the ringtone is sounded, and elderly people can receive calls with peace of mind. With this mechanism, elderly people can receive calls with peace of mind. It is possible to reduce the risk of fraud and realize a situation in which only safe calls are received. For example, the “risk of fraud” can be reduced, and elderly people can receive calls with peace of mind. In addition, since only calls from family members or friends are received, elderly people can receive calls with peace of mind. As a result, the telephone call receiving system allows elderly people to receive calls with peace of mind.

The telephone call receiving system according to the embodiment includes an analysis unit, a determination unit, and a ringing unit. The analysis unit analyzes the content of a telephone call. The analysis unit, for example, converts the content of the telephone call into text using speech recognition technology. The analysis unit can convert the content of the telephone call into text with high accuracy by using deep learning-based speech recognition technology. The analysis unit can also convert the content of the telephone call into text using HMM-based speech recognition technology. The analysis unit can convert the content of the telephone call into text in real time using speech recognition technology. The determination unit determines, based on the content analyzed by the analysis unit, whether the call is a safe call. The determination unit, for example, determines that calls from family members or friends are safe. The determination unit can determine that calls from persons registered in the contact list are safe. The determination unit can also determine that calls from specific phone numbers are safe. The determination unit can preferentially determine that calls from family members or friends are safe. The determination unit determines that calls containing keywords indicative of possible fraud are not safe. The determination unit can determine that calls containing keywords such as “money,” “transfer,” or “emergency” are not safe. The determination unit can also refer to the latest information on fraud schemes to update the keywords indicative of possible fraud. The determination unit can automatically extract keywords indicative of possible fraud and determine that such calls are not safe. The ringing unit sounds a ringtone when the determination unit determines that the call is a safe call. The ringing unit can sound a ringtone only when the call is a safe call. The ringing unit can sound a ringtone only when a call is received from a family member or friend. The ringing unit can also sound a ringtone only when a call is received from a specific phone number. The ringing unit can sound a specific ringtone when it is determined to be a safe call. As a result, the telephone call receiving system according to the embodiment allows elderly people to receive calls with peace of mind.

The analysis unit analyzes the content of a telephone call. The analysis unit, for example, converts the content of the telephone call into text using speech recognition technology. Specifically, by using deep learning-based speech recognition technology, the content of the telephone call can be converted into text with high accuracy. Deep learning technology can accurately capture the characteristics of speech by learning from a large amount of voice data, making it possible to recognize speech accurately even in noisy environments. HMM (Hidden Markov Model)-based speech recognition technology can also be used. HMM can efficiently analyze continuous speech data by modeling the temporal changes in speech. By combining these technologies, the analysis unit can convert the content of the telephone call into text in real time. Furthermore, the analysis unit can analyze the meaning of the text using natural language processing technology in addition to speech recognition technology. For example, important keywords can be extracted from the text and the content of the call can be summarized. As a result, the analysis unit can analyze the content of the call in detail and generate highly accurate data to be provided to the determination unit.

The determination unit determines, based on the content analyzed by the analysis unit, whether the call is a safe call. The determination unit, for example, determines that calls from family members or friends are safe. Specifically, the determination unit can determine that calls from persons registered in the contact list are safe. The contact list is a database including phone numbers and names registered by the user in advance, and the determination unit checks the caller by referring to this list. The determination unit can also determine that calls from specific phone numbers are safe. For example, by registering phone numbers of reliable institutions such as banks or medical institutions in advance, these calls can be determined to be safe. Furthermore, the determination unit determines that calls containing keywords indicative of possible fraud are not safe. For example, the determination unit can determine that calls containing keywords such as “money,” “transfer,” or “emergency” are not safe. The determination unit can refer to the latest information on fraud schemes to update the keywords indicative of possible fraud. As a result, the determination unit can always determine safety based on the latest fraud information. The determination unit can also use AI to analyze the content of the call and automatically extract keywords indicative of possible fraud. By learning from past fraudulent call data, AI can recognize fraud patterns and respond to new fraud schemes. As a result, the determination unit can determine safety with high accuracy and provide an environment where users can receive calls with peace of mind.

The ringing unit sounds a ringtone when the determination unit determines that the call is a safe call. Specifically, the ringtone can be sounded only when the call is a safe call. For example, the ringtone can be sounded only when a call is received from a family member or friend. The ringing unit can also sound a ringtone only when a call is received from a specific phone number. As a result, the user can receive important calls without missing them. Furthermore, the ringing unit can sound a specific ringtone when it is determined to be a safe call. For example, a specific melody can be set for calls from family members, and a different melody can be set for calls from friends, allowing the user to intuitively identify the caller. Furthermore, the ringing unit can customize the ringtone according to the user's preferences. For example, a quiet ringtone can be set during certain time periods, and a loud notification can be provided in emergencies. As a result, the ringing unit can provide flexible notification methods tailored to the user's lifestyle. Furthermore, the ringing unit can use not only ringtones but also notifications such as vibration or flashing lights. This allows the system to accommodate users with hearing impairments or those who need to receive calls in quiet environments. As a result, the telephone call receiving system according to the embodiment can not only allow elderly people to receive calls with peace of mind but also accommodate various user needs.

The analysis unit can convert the content of a telephone call into text using speech recognition technology. The analysis unit can, for example, convert the content of the telephone call into text with high accuracy using deep learning-based speech recognition technology. The analysis unit can also convert the content of the telephone call into text using HMM-based speech recognition technology. The analysis unit can, for example, convert the content of the telephone call into text in real time using speech recognition technology. As a result, converting the content of the call into text improves the accuracy of analysis. Speech recognition technology includes, for example, deep learning-based speech recognition technology and HMM-based speech recognition technology, but is not limited to these examples. Some or all of the above-described processing in the analysis unit may be performed using generative AI, or may be performed without using generative AI. For example, the analysis unit can input the voice data of the call to generative AI and have the generative AI perform the conversion from voice data to text data.

The determination unit can determine that calls from family members or friends are safe. The determination unit can, for example, determine that calls from persons registered in the contact list are safe. The determination unit can also determine that calls from specific phone numbers are safe. The determination unit can preferentially determine that calls from family members or friends are safe. As a result, by determining that calls from family members or friends are safe, elderly people can receive calls with peace of mind. Family members or friends include, for example, persons registered in the contact list or calls from specific phone numbers, but are not limited to these examples. Some or all of the above-described processing in the determination unit may be performed using generative AI, or may be performed without using generative AI. For example, the determination unit can input caller information to generative AI and have the generative AI determine whether the call is a safe call based on the caller information.

The determination unit can determine that calls containing keywords indicative of possible fraud are not safe. The determination unit can, for example, determine that calls containing keywords such as “money,” “transfer,” or “emergency” are not safe. The determination unit can refer to the latest information on fraud schemes to update the keywords indicative of possible fraud. The determination unit can automatically extract keywords indicative of possible fraud and determine that such calls are not safe. As a result, the risk of fraud can be reduced. Keywords indicative of possible fraud include, for example, “money,” “transfer,” “emergency,” and the like, but are not limited to these examples. Some or all of the above-described processing in the determination unit may be performed using generative AI, or may be performed without using generative AI. For example, the determination unit can input the content of the call to generative AI and have the generative AI extract keywords indicative of possible fraud.

The ringing unit can sound a ringtone only when the call is a safe call. The ringing unit can, for example, sound a ringtone only when the call is a safe call. The ringing unit can, for example, sound a ringtone only when a call is received from a family member or friend. The ringing unit can also sound a ringtone only when a call is received from a specific phone number. The ringing unit can, for example, sound a specific ringtone when it is determined to be a safe call. As a result, elderly people can receive calls with peace of mind. Safe calls include, for example, calls from family members or friends or calls from specific phone numbers, but are not limited to these examples. Some or all of the above-described processing in the ringing unit may be performed using generative AI, or may be performed without using generative AI. For example, the ringing unit can input information determined by the determination unit to be a safe call to generative AI and have the generative AI perform the ringing of the ringtone.

The analysis unit can estimate the user's emotion when analyzing the content of a telephone call and adjust the analysis accuracy based on the estimated user emotion. For example, if the user is nervous, AI can detect the emotion and focus on specific keywords to improve analysis accuracy. If the user is relaxed, AI can detect the emotion and adjust the analysis accuracy to analyze a broader range of content. If the user is excited, AI can detect the emotion and adjust the analysis accuracy to emphasize keywords with a high likelihood of fraud. As a result, adjusting the analysis accuracy according to the user's emotion improves analysis accuracy. The user's emotion is estimated based on, for example, voice tone, word choice, and speech patterns, but is not limited to these examples. Emotion estimation is implemented using, for example, an emotion engine or generative AI with emotion estimation functionality. Generative AI may be a text generation AI (e.g., LLM) or a multimodal generative AI, but is not limited to these examples. Some or all of the above-described processing in the analysis unit may be performed using generative AI, or may be performed without using generative AI. For example, the analysis unit can input the voice data of the call to generative AI and have the generative AI perform estimation of the user's emotion.

The analysis unit can support different languages and dialects when converting the content of a telephone call into text using speech recognition technology. The analysis unit can, for example, have AI automatically detect different languages and select an appropriate speech recognition model to convert the content into text. The analysis unit can, for example, use a dictionary to recognize dialects or region-specific words and convert them into standard language. The analysis unit can, for example, adjust the accuracy of speech recognition and perform text conversion based on the language set by the user. As a result, supporting different languages and dialects improves the accuracy of analysis. Different languages and dialects include, for example, the use of multilingual speech recognition engines or dialect dictionaries, but are not limited to these examples. Some or all of the above-described processing in the analysis unit may be performed using generative AI, or may be performed without using generative AI. For example, the analysis unit can input the voice data of the call to generative AI and have the generative AI perform text conversion corresponding to different languages and dialects.

The analysis unit can remove background sounds and noise when analyzing the content of a telephone call to improve analysis accuracy. The analysis unit can, for example, have AI filter background sounds in real time and extract only the main voice for analysis. The analysis unit can, for example, use noise canceling technology to clarify the content of the call. The analysis unit can, for example, emphasize specific frequency bands and reduce noise to improve the accuracy of speech recognition. As a result, removing background sounds and noise improves the accuracy of analysis. Background sounds and noise include, for example, noise canceling technology and filtering technology, but are not limited to these examples. Some or all of the above-described processing in the analysis unit may be performed using generative AI, or may be performed without using generative AI. For example, the analysis unit can input the voice data of the call to generative AI and have the generative AI perform removal of background sounds and noise.

The analysis unit can estimate the user's emotion when analyzing the content of a telephone call and adjust the display method of the analysis result based on the estimated user emotion. For example, if the user is nervous, the analysis result can be displayed concisely and only important information can be emphasized. If the user is relaxed, detailed analysis results can be displayed and additional information can be provided. If the user is excited, the analysis result can be displayed in a visually easy-to-understand manner and important keywords can be emphasized. As a result, adjusting the display method of the analysis result according to the user's emotion deepens the understanding of the analysis result. The user's emotion is estimated based on, for example, voice tone, word choice, and speech patterns, but is not limited to these examples. Emotion estimation is implemented using, for example, an emotion engine or generative AI with emotion estimation functionality. Generative AI may be a text generation AI (e.g., LLM) or a multimodal generative AI, but is not limited to these examples. Some or all of the above-described processing in the analysis unit may be performed using generative AI, or may be performed without using generative AI. For example, the analysis unit can input the voice data of the call to generative AI and have the generative AI perform estimation of the user's emotion.

The analysis unit can highlight specific keywords or phrases when converting the content of a telephone call into text using speech recognition technology. The analysis unit can, for example, automatically detect keywords indicative of possible fraud and highlight them in the text. The analysis unit can, for example, highlight important phrases such as the names of family members or friends. The analysis unit can, for example, highlight specific keywords set by the user. As a result, highlighting specific keywords or phrases makes it less likely that important information will be overlooked. Specific keywords or phrases include, for example, “important,” “emergency,” “confirmation,” and the like, but are not limited to these examples. Some or all of the above-described processing in the analysis unit may be performed using generative AI, or may be performed without using generative AI. For example, the analysis unit can input the voice data of the call to generative AI and have the generative AI perform highlighting of specific keywords or phrases.

The analysis unit can refer to past call history when analyzing the content of a telephone call to improve analysis accuracy. The analysis unit can, for example, analyze past call history to identify frequently used phrases or keywords. The analysis unit can, for example, learn specific patterns from past call history to improve analysis accuracy. The analysis unit can, for example, identify calls with a high likelihood of fraud based on past call history to improve analysis accuracy. As a result, referring to past call history improves the accuracy of analysis. Past call history includes, for example, the retention period of call content and the frequency of reference, but is not limited to these examples. Some or all of the above-described processing in the analysis unit may be performed using generative AI, or may be performed without using generative AI. For example, the analysis unit can input past call history data to generative AI and have the generative AI perform analysis of the call history.

The determination unit can estimate the user's emotion and adjust the criteria for determining whether the call is a safe call based on the estimated user emotion. For example, if the user is nervous, the determination criteria can be made stricter to more rigorously determine calls with a high likelihood of fraud. If the user is relaxed, the determination criteria can be loosened and calls from family members or friends can be preferentially determined as safe. If the user is excited, the determination criteria can be adjusted and determination can be made based on important keywords. As a result, adjusting the determination criteria according to the user's emotion improves the accuracy of determination. The user's emotion is estimated based on, for example, voice tone, word choice, and speech patterns, but is not limited to these examples. Emotion estimation is implemented using, for example, an emotion engine or generative AI with emotion estimation functionality. Generative AI may be a text generation AI (e.g., LLM) or a multimodal generative AI, but is not limited to these examples. Some or all of the above-described processing in the determination unit may be performed using generative AI, or may be performed without using generative AI. For example, the determination unit can input the voice data of the call to generative AI and have the generative AI perform estimation of the user's emotion.

The determination unit can refer to call history and contact lists to improve the accuracy of determining that calls from family members or friends are safe calls. The determination unit can, for example, analyze call history and determine that frequently called parties are safe calls. The determination unit can, for example, refer to the contact list and determine that calls from registered family members or friends are safe. The determination unit can, for example, combine call history and contact lists to improve the accuracy of determination. As a result, referring to call history and contact lists improves the accuracy of determination. Call history and contact lists include, for example, call frequency and contact reliability, but are not limited to these examples. Some or all of the above-described processing in the determination unit may be performed using generative AI, or may be performed without using generative AI. For example, the determination unit can input call history data and contact lists to generative AI and have the generative AI perform analysis of the call history and contact lists.

The determination unit can refer to the latest information on fraud schemes to update the determination criteria when determining that calls containing keywords indicative of possible fraud are not safe calls. The determination unit can, for example, periodically update the latest information on fraud schemes and reflect it in the determination criteria. The determination unit can, for example, automatically update the list of keywords indicative of possible fraud and incorporate it into the determination criteria. The determination unit can, for example, refer to news and reports on fraud schemes and adjust the determination criteria. As a result, referring to the latest information on fraud schemes keeps the determination criteria up to date. The latest information on fraud schemes includes, for example, police databases and security company reports, but is not limited to these examples. Some or all of the above-described processing in the determination unit may be performed using generative AI, or may be performed without using generative AI. For example, the determination unit can input the latest information on fraud schemes to generative AI and have the generative AI perform updating of the determination criteria.

The determination unit can estimate the user's emotion and adjust the notification method of the determination result based on the estimated user emotion. For example, if the user is nervous, a concise and clear notification method can be provided. If the user is relaxed, a detailed notification method can be provided and additional information can be displayed. If the user is excited, a visually easy-to-understand notification method can be provided. As a result, adjusting the notification method according to the user's emotion deepens the understanding of the notification. The user's emotion is estimated based on, for example, voice tone, word choice, and speech patterns, but is not limited to these examples. Emotion estimation is implemented using, for example, an emotion engine or generative AI with emotion estimation functionality. Generative AI may be a text generation AI (e.g., LLM) or a multimodal generative AI, but is not limited to these examples. Some or all of the above-described processing in the determination unit may be performed using generative AI, or may be performed without using generative AI. For example, the determination unit can input the voice data of the call to generative AI and have the generative AI perform estimation of the user's emotion.

The determination unit can consider the frequency and time of calls to improve the accuracy of determining that calls from family members or friends are safe calls. The determination unit can, for example, analyze the frequency of calls and determine that frequently called parties are safe calls. The determination unit can, for example, consider the time of calls and determine that calls received during normal hours are safe. The determination unit can, for example, combine the frequency and time of calls to improve the accuracy of determination. As a result, considering the frequency and time of calls improves the accuracy of determination. The frequency and time of calls include, for example, the number of calls and the time of calls, but are not limited to these examples. Some or all of the above-described processing in the determination unit may be performed using generative AI, or may be performed without using generative AI. For example, the determination unit can input call history data to generative AI and have the generative AI perform analysis of the frequency and time of calls.

The determination unit can consider not only the content of the call but also the caller information when determining that calls containing keywords indicative of possible fraud are not safe calls. The determination unit can, for example, analyze the caller's phone number and identify numbers with a high likelihood of fraud. The determination unit can, for example, refer to the caller's regional information and identify calls from regions with a high likelihood of fraud. The determination unit can, for example, combine caller information and call content to improve the accuracy of determination. As a result, considering caller information improves the accuracy of determination. Caller information includes, for example, the caller's phone number and location, but is not limited to these examples. Some or all of the above-described processing in the determination unit may be performed using generative AI, or may be performed without using generative AI. For example, the determination unit can input caller information to generative AI and have the generative AI perform analysis of the caller information.

The ringing unit can estimate the user's emotion and adjust the type and volume of the ringtone based on the estimated user emotion. For example, if the user is nervous, a calm-toned ringtone can be set. If the user is relaxed, a bright-toned ringtone can be set. If the user is excited, the volume can be adjusted to set an appropriate ringtone. As a result, adjusting the type and volume of the ringtone according to the user's emotion allows for more appropriate ringtones. The user's emotion is estimated based on, for example, voice tone, word choice, and speech patterns, but is not limited to these examples. Emotion estimation is implemented using, for example, an emotion engine or generative AI with emotion estimation functionality. Generative AI may be a text generation AI (e.g., LLM) or a multimodal generative AI, but is not limited to these examples. Some or all of the above-described processing in the ringing unit may be performed using generative AI, or may be performed without using generative AI. For example, the ringing unit can input the user's emotion data to generative AI and have the generative AI perform adjustment of the type and volume of the ringtone.

The ringing unit can adjust the ringing timing by considering the user's schedule and activity status when sounding the ringtone only for safe calls. The ringing unit can, for example, refer to the user's calendar information and not sound the ringtone during important meetings. The ringing unit can, for example, monitor the user's activity status in real time and not sound the ringtone during exercise or sleep. The ringing unit can, for example, sound the ringtone at the optimal timing based on the user's schedule. As a result, the ringtone can be sounded at the optimal timing according to the user's schedule and activity status. The user's schedule and activity status include, for example, calendar apps and activity trackers, but are not limited to these examples. Some or all of the above-described processing in the ringing unit may be performed using generative AI, or may be performed without using generative AI. For example, the ringing unit can input the user's schedule information to generative AI and have the generative AI perform adjustment of the ringing timing.

The ringing unit can provide customizable ringtones according to the user's preferences when sounding the ringtone. The ringing unit can, for example, set music or sound effects selected by the user as the ringtone. The ringing unit can, for example, provide ringtones that reflect the user's customized volume and tone. The ringing unit can, for example, set different ringtones for each specific contact set by the user. As a result, setting ringtones according to the user's preferences provides a more comfortable user experience. User preferences include, for example, user settings and past selection history, but are not limited to these examples. Some or all of the above-described processing in the ringing unit may be performed using generative AI, or may be performed without using generative AI. For example, the ringing unit can input user preference data to generative AI and have the generative AI provide customizable ringtones.

The ringing unit can estimate the user's emotion and adjust the ringing duration of the ringtone based on the estimated user emotion. For example, if the user is nervous, a short ringing duration can be set. If the user is relaxed, a longer ringing duration can be set. If the user is excited, an appropriate ringing duration can be set. As a result, adjusting the ringing duration of the ringtone according to the user's emotion allows for more appropriate ringtones. The user's emotion is estimated based on, for example, voice tone, word choice, and speech patterns, but is not limited to these examples. Emotion estimation is implemented using, for example, an emotion engine or generative AI with emotion estimation functionality. Generative AI may be a text generation AI (e.g., LLM) or a multimodal generative AI, but is not limited to these examples. Some or all of the above-described processing in the ringing unit may be performed using generative AI, or may be performed without using generative AI. For example, the ringing unit can input the user's emotion data to generative AI and have the generative AI perform adjustment of the ringing duration of the ringtone.

The ringing unit can set the optimal volume by considering the user's device settings and ambient sounds when sounding the ringtone only for safe calls. The ringing unit can, for example, automatically set the appropriate volume based on the user's device settings. The ringing unit can, for example, detect ambient sounds in real time and set the optimal volume. The ringing unit can, for example, customize the volume according to the user's preferences. As a result, setting the optimal volume according to the user's device settings and ambient sounds allows for more appropriate ringtones. The user's device settings and ambient sounds include, for example, device volume settings and surrounding noise levels, but are not limited to these examples. Some or all of the above-described processing in the ringing unit may be performed using generative AI, or may be performed without using generative AI. For example, the ringing unit can input the user's device settings and ambient sound data to generative AI and have the generative AI perform setting of the optimal volume.

The ringing unit can refer to the user's past response history to adjust the ringing pattern when sounding the ringtone. The ringing unit can, for example, analyze the times when the user responded in the past and adjust the ringing pattern to match those times. The ringing unit can, for example, learn the optimal ringing pattern from the user's past response history and apply it. The ringing unit can, for example, set a ringing pattern that makes it easier for the user to respond during specific times. As a result, referring to the user's past response history allows for setting the optimal ringing pattern. The user's past response history includes, for example, response frequency and response times, but are not limited to these examples. Some or all of the above-described processing in the ringing unit may be performed using generative AI, or may be performed without using generative AI. For example, the ringing unit can input the user's past response history data to generative AI and have the generative AI perform adjustment of the ringing pattern.

The system according to the embodiment is not limited to the above-described examples and can be variously modified as follows, for example.

The analysis unit can estimate the user's emotion when analyzing the content of a telephone call and adjust the analysis accuracy based on the estimated user emotion. For example, if the user is nervous, AI can detect the emotion and focus on specific keywords to improve analysis accuracy. If the user is relaxed, AI can detect the emotion and adjust the analysis accuracy to analyze a broader range of content. If the user is excited, AI can detect the emotion and adjust the analysis accuracy to emphasize keywords with a high likelihood of fraud. As a result, adjusting the analysis accuracy according to the user's emotion improves analysis accuracy. The user's emotion is estimated based on, for example, voice tone, word choice, and speech patterns, but is not limited to these examples. Emotion estimation is implemented using, for example, an emotion engine or generative AI with emotion estimation functionality. Generative AI may be a text generation AI (e.g., LLM) or a multimodal generative AI, but is not limited to these examples. Some or all of the above-described processing in the analysis unit may be performed using generative AI, or may be performed without using generative AI. For example, the analysis unit can input the voice data of the call to generative AI and have the generative AI perform estimation of the user's emotion.

The analysis unit can support different languages and dialects when converting the content of a telephone call into text using speech recognition technology. The analysis unit can, for example, have AI automatically detect different languages and select an appropriate speech recognition model to convert the content into text. The analysis unit can, for example, use a dictionary to recognize dialects or region-specific words and convert them into standard language. The analysis unit can, for example, adjust the accuracy of speech recognition and perform text conversion based on the language set by the user. As a result, supporting different languages and dialects improves the accuracy of analysis. Different languages and dialects include, for example, the use of multilingual speech recognition engines or dialect dictionaries, but are not limited to these examples. Some or all of the above-described processing in the analysis unit may be performed using generative AI, or may be performed without using generative AI. For example, the analysis unit can input the voice data of the call to generative AI and have the generative AI perform text conversion corresponding to different languages and dialects.

The determination unit can estimate the user's emotion and adjust the criteria for determining whether the call is a safe call based on the estimated user emotion. For example, if the user is nervous, the determination criteria can be made stricter to more rigorously determine calls with a high likelihood of fraud. If the user is relaxed, the determination criteria can be loosened and calls from family members or friends can be preferentially determined as safe. If the user is excited, the determination criteria can be adjusted and determination can be made based on important keywords. As a result, adjusting the determination criteria according to the user's emotion improves the accuracy of determination. The user's emotion is estimated based on, for example, voice tone, word choice, and speech patterns, but is not limited to these examples. Emotion estimation is implemented using, for example, an emotion engine or generative AI with emotion estimation functionality. Generative AI may be a text generation AI (e.g., LLM) or a multimodal generative AI, but is not limited to these examples. Some or all of the above-described processing in the determination unit may be performed using generative AI, or may be performed without using generative AI. For example, the determination unit can input the voice data of the call to generative AI and have the generative AI perform estimation of the user's emotion.

The analysis unit can remove background sounds and noise when analyzing the content of a telephone call to improve analysis accuracy. The analysis unit can, for example, have AI filter background sounds in real time and extract only the main voice for analysis. The analysis unit can, for example, use noise canceling technology to clarify the content of the call. The analysis unit can, for example, emphasize specific frequency bands and reduce noise to improve the accuracy of speech recognition. As a result, removing background sounds and noise improves the accuracy of analysis. Background sounds and noise include, for example, noise canceling technology and filtering technology, but are not limited to these examples. Some or all of the above-described processing in the analysis unit may be performed using generative AI, or may be performed without using generative AI. For example, the analysis unit can input the voice data of the call to generative AI and have the generative AI perform removal of background sounds and noise.

The determination unit can refer to the latest information on fraud schemes to update the determination criteria when determining that calls containing keywords indicative of possible fraud are not safe calls. The determination unit can, for example, periodically update the latest information on fraud schemes and reflect it in the determination criteria. The determination unit can, for example, automatically update the list of keywords indicative of possible fraud and incorporate it into the determination criteria. The determination unit can, for example, refer to news and reports on fraud schemes and adjust the determination criteria. As a result, referring to the latest information on fraud schemes keeps the determination criteria up to date. The latest information on fraud schemes includes, for example, police databases and security company reports, but are not limited to these examples. Some or all of the above-described processing in the determination unit may be performed using generative AI, or may be performed without using generative AI. For example, the determination unit can input the latest information on fraud schemes to generative AI and have the generative AI perform updating of the determination criteria.

The ringing unit can estimate the user's emotion and adjust the type and volume of the ringtone based on the estimated user emotion. For example, if the user is nervous, a calm-toned ringtone can be set. If the user is relaxed, a bright-toned ringtone can be set. If the user is excited, the volume can be adjusted to set an appropriate ringtone. As a result, adjusting the type and volume of the ringtone according to the user's emotion allows for more appropriate ringtones. The user's emotion is estimated based on, for example, voice tone, word choice, and speech patterns, but is not limited to these examples. Emotion estimation is implemented using, for example, an emotion engine or generative AI with emotion estimation functionality. Generative AI may be a text generation AI (e.g., LLM) or a multimodal generative AI, but is not limited to these examples. Some or all of the above-described processing in the ringing unit may be performed using generative AI, or may be performed without using generative AI. For example, the ringing unit can input the user's emotion data to generative AI and have the generative AI perform adjustment of the type and volume of the ringtone.

The ringing unit can adjust the ringing timing by considering the user's schedule and activity status when sounding the ringtone only for safe calls. The ringing unit can, for example, refer to the user's calendar information and not sound the ringtone during important meetings. The ringing unit can, for example, monitor the user's activity status in real time and not sound the ringtone during exercise or sleep. The ringing unit can, for example, sound the ringtone at the optimal timing based on the user's schedule. As a result, the ringtone can be sounded at the optimal timing according to the user's schedule and activity status. The user's schedule and activity status include, for example, calendar apps and activity trackers, but are not limited to these examples. Some or all of the above-described processing in the ringing unit may be performed using generative AI, or may be performed without using generative AI. For example, the ringing unit can input the user's schedule information to generative AI and have the generative AI perform adjustment of the ringing timing.

The analysis unit can refer to past call history when analyzing the content of a telephone call to improve analysis accuracy. The analysis unit can, for example, analyze past call history to identify frequently used phrases or keywords. The analysis unit can, for example, learn specific patterns from past call history to improve analysis accuracy. The analysis unit can, for example, identify calls with a high likelihood of fraud based on past call history to improve analysis accuracy. As a result, referring to past call history improves the accuracy of analysis. Past call history includes, for example, the retention period of call content and the frequency of reference, but is not limited to these examples. Some or all of the above-described processing in the analysis unit may be performed using generative AI, or may be performed without using generative AI. For example, the analysis unit can input past call history data to generative AI and have the generative AI perform analysis of the call history.

The determination unit can estimate the user's emotion and adjust the notification method of the determination result based on the estimated user's emotion. For example, when the user is nervous, the determination unit can provide a concise and clear notification method. When the user is relaxed, the determination unit can provide a detailed notification method and display additional information. When the user is excited, the determination unit can provide a visually easy-to-understand notification method. By adjusting the notification method according to the user's emotion, the user's understanding of the notification is enhanced. The user's emotion is estimated based on, for example, voice tone, choice of words, speaking patterns, and the like, but is not limited to such examples. The estimation of emotion is realized using, for example, an emotion engine or an emotion estimation function utilizing generative AI. The generative AI may be a text generative AI (for example, LLM) or a multimodal generative AI, but is not limited thereto. Some or all of the above-described processing in the determination unit may be performed using generative AI, or may be performed without using generative AI. For example, the determination unit can input telephone voice data to the generative AI and have the generative AI estimate the user's emotion.

The ringing unit can set the optimal volume by considering the user's device settings and ambient sounds when sounding the ringtone only for safe calls. The ringing unit can, for example, automatically set the appropriate volume based on the user's device settings. The ringing unit can, for example, detect ambient sounds in real time and set the optimal volume. The ringing unit can, for example, customize the volume according to the user's preferences. As a result, setting the optimal volume according to the user's device settings and ambient sounds allows for more appropriate ringtones. The user's device settings and ambient sounds include, for example, device volume settings and surrounding noise levels, but are not limited to these examples. Some or all of the above-described processing in the ringing unit may be performed using generative AI, or may be performed without using generative AI. For example, the ringing unit can input the user's device settings and ambient sound data to generative AI and have the generative AI perform setting of the optimal volume.

The following is a brief description of the processing flow of Example 2 of the Embodiment.
Step 1: The analysis unit analyzes the content of a telephone call. The analysis unit converts the content of the telephone call into text using speech recognition technology. For example, deep learning-based speech recognition technology or HMM-based speech recognition technology can be used to convert the content of the telephone call into text with high accuracy and in real time.
Step 2: The determination unit determines, based on the content analyzed by the analysis unit, whether the call is a safe call. The determination unit determines that calls from family members or friends or from persons registered in the contact list are safe. In addition, the determination unit determines that calls containing keywords indicative of possible fraud are not safe and can update the keywords by referring to the latest information on fraud schemes.
Step 3: The ringing unit sounds a ringtone when the determination unit determines that the call is a safe call. For example, the ringtone can be sounded only when a call is received from a family member or friend or from a specific phone number. In addition, a specific ringtone can be sounded when it is determined to be a safe call.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT® (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the above-described analysis unit, determination unit, and ringing unit is implemented, for example, in at least one of the smart device 14 and the data processing apparatus 12. For example, the analysis unit is implemented by the processor 46 of the smart device 14 and converts the content of the telephone call into text using speech recognition technology. The determination unit is implemented, for example, by a specific processing unit 290 of the data processing apparatus 12 and determines whether the call is a safe call based on the analyzed content. The ringing unit is implemented, for example, by a control unit 46A of the smart device 14 and sounds a ringtone when it is determined to be a safe call. The correspondence between each unit and the device or control unit is not limited to the above examples and various modifications are possible.

### Second Embodiment

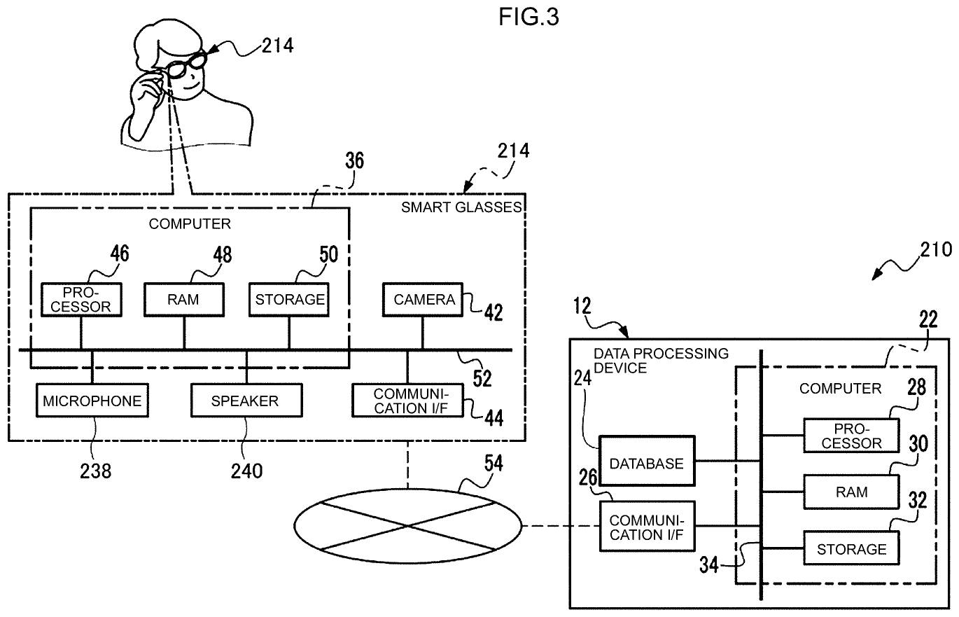

FIG. 3 shows an example configuration of a data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 includes a computer 36, a microphone 238, a speaker 240, a camera 42, and a communication I/F 44. The computer 36 includes a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

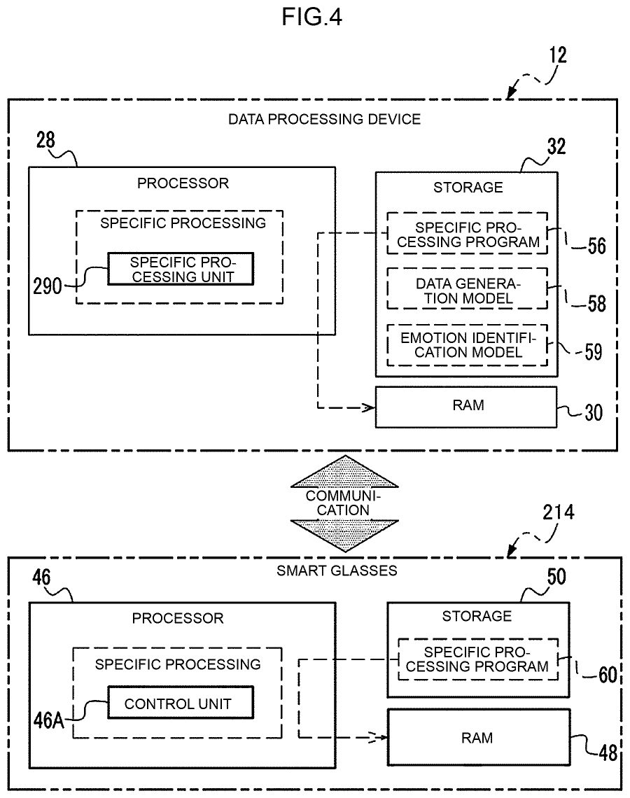

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the above-described analysis unit, determination unit, and ringing unit is implemented, for example, in at least one of the smart glasses 214 and the data processing apparatus 12. For example, the analysis unit is implemented by the processor 46 of the smart glasses 214 and converts the content of the telephone call into text using speech recognition technology. The determination unit is implemented, for example, by a specific processing unit 290 of the data processing apparatus 12 and determines whether the call is a safe call based on the analyzed content. The ringing unit is implemented, for example, by a control unit 46A of the smart glasses 214 and sounds a ringtone when it is determined to be a safe call. The correspondence between each unit and the device or control unit is not limited to the above examples and various modifications are possible.

### Third Embodiment

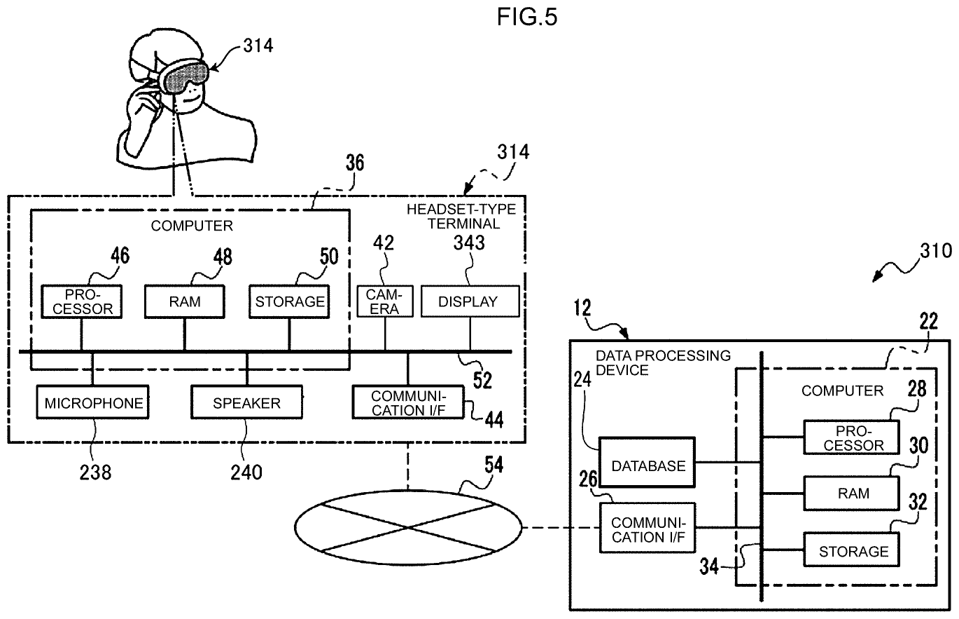

FIG. 5 shows an example configuration of a data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 includes a computer 36, a microphone 238, a speaker 240, a camera 42, a communication I/F 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

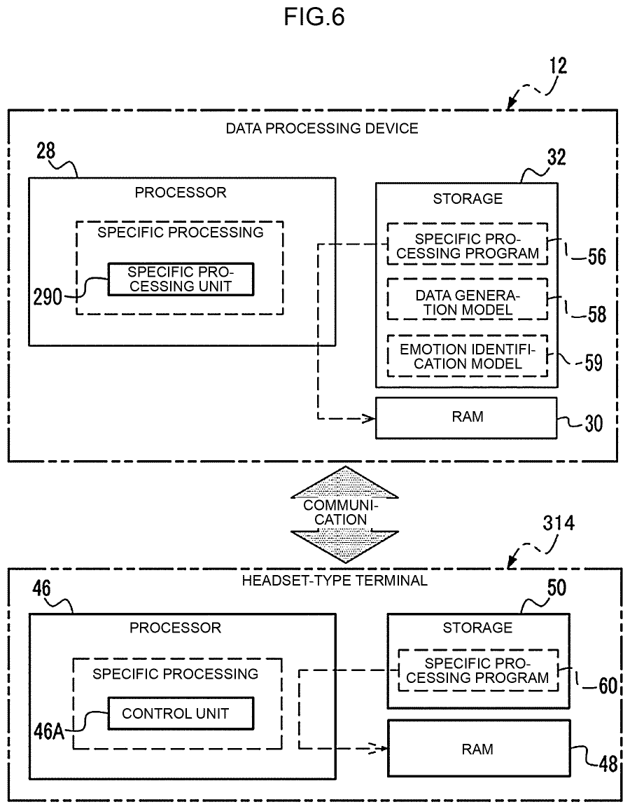

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the above-described analysis unit, determination unit, and ringing unit is implemented, for example, in at least one of the headset-type terminal 314 and the data processing apparatus 12. For example, the analysis unit is implemented by the processor 46 of the headset-type terminal 314 and converts the content of the telephone call into text using speech recognition technology. The determination unit is implemented, for example, by a specific processing unit 290 of the data processing apparatus 12 and determines whether the call is a safe call based on the analyzed content. The ringing unit is implemented, for example, by a control unit 46A of the headset-type terminal 314 and sounds a ringtone when it is determined to be a safe call. The correspondence between each unit and the device or control unit is not limited to the above examples and various modifications are possible.

### FOURTH EMBODIMENT

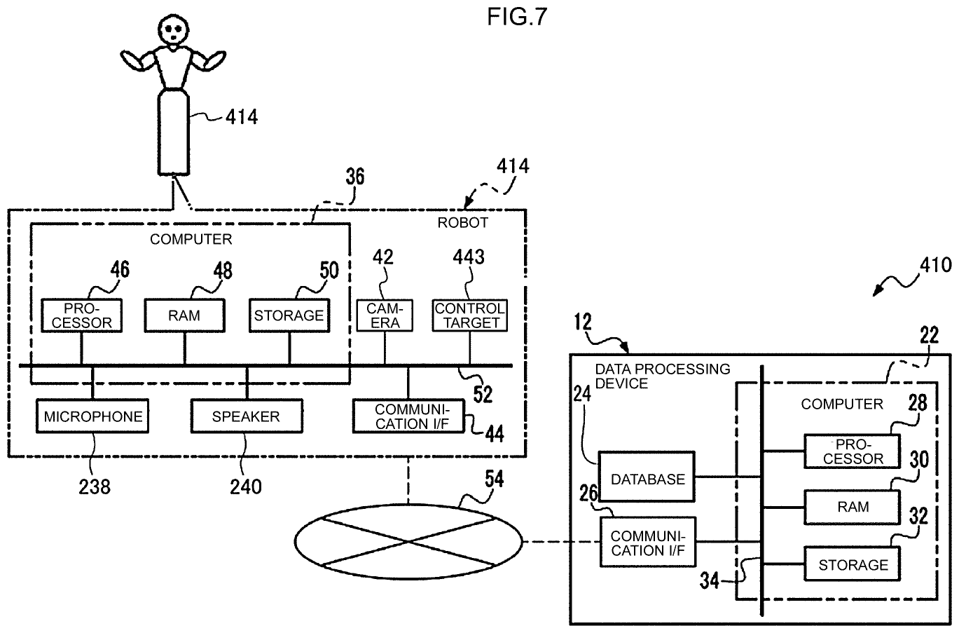

FIG. 7 shows an example configuration of a data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 includes a computer 36, a microphone 238, a speaker 240, a camera 42, a communication I/F 44, and a control target 443. The computer 36 includes a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

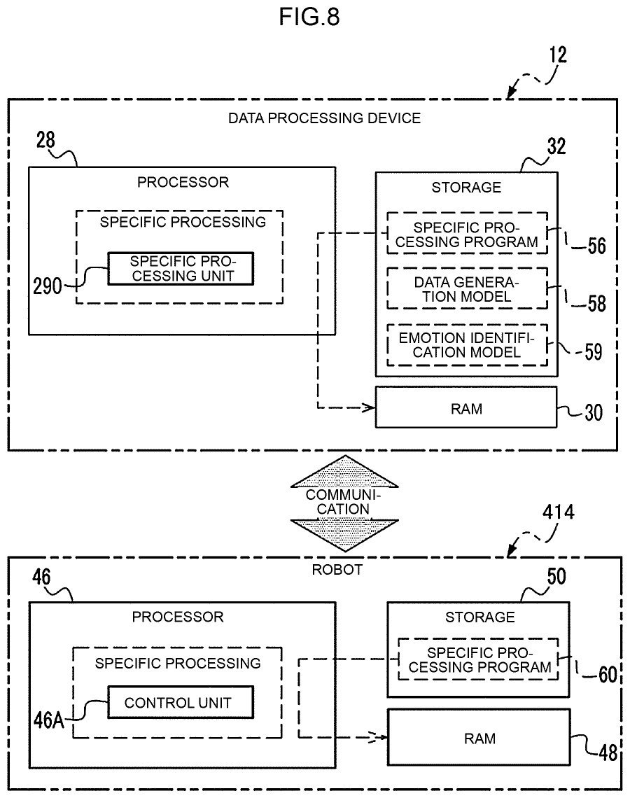

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the above-described analysis unit, determination unit, and ringing unit is implemented, for example, in at least one of the robot 414 and the data processing apparatus 12. For example, the analysis unit is implemented by the processor 46 of the robot 414 and converts the content of the telephone call into text using speech recognition technology. The determination unit is implemented, for example, by a specific processing unit 290 of the data processing apparatus 12 and determines whether the call is a safe call based on the analyzed content. The ringing unit is implemented, for example, by a control unit 46A of the robot 414 and sounds a ringtone when it is determined to be a safe call. The correspondence between each unit and the device or control unit is not limited to the above examples and various modifications are possible.

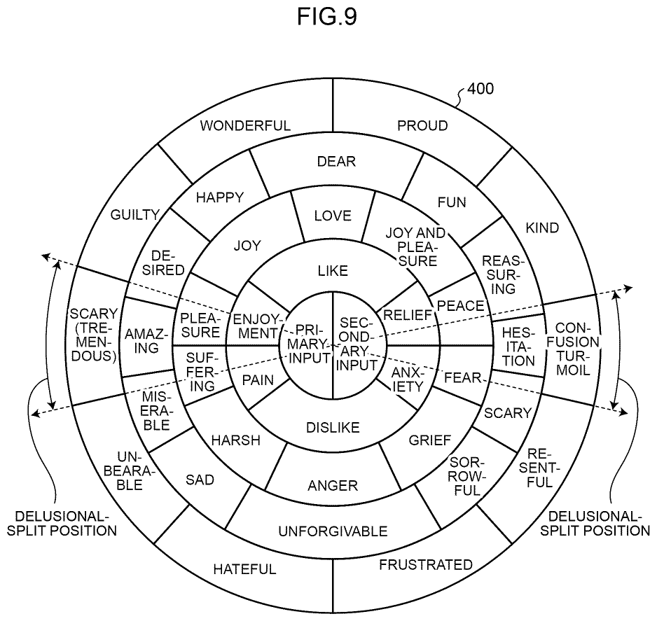

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

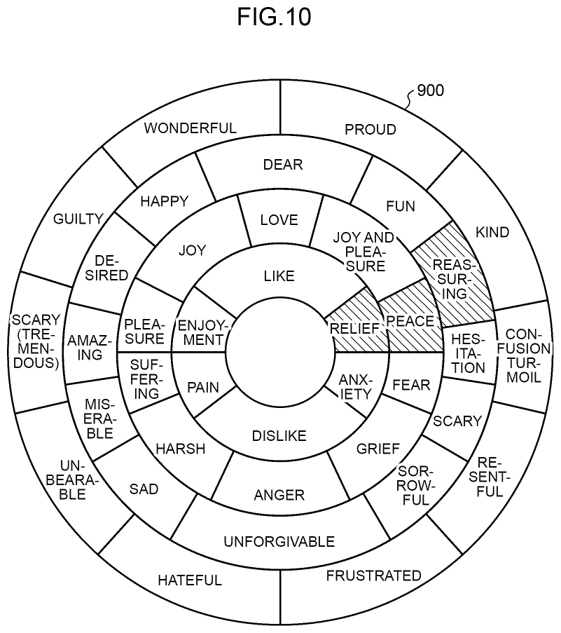

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used. Additionally, the examples described above were explained by dividing into form example 1 and form example 2, but these may be combined.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
[Additional Note 1] A system including: an analysis unit configured to analyze the content of a telephone call; a determination unit configured to determine, based on the content analyzed by the analysis unit, whether the call is a safe call; and a ringing unit configured to sound a ringtone when the determination unit determines that the call is a safe call.
[Additional Note 2] The system according to Additional Note 1, wherein the analysis unit is configured to convert the content of the telephone call into text using speech recognition technology.
[Additional Note 3] The system according to Additional Note 1, wherein the determination unit is configured to determine that calls from family members or friends are safe calls.
[Additional Note 4] The system according to Additional Note 1, wherein the determination unit is configured to determine that calls containing keywords indicative of possible fraud are not safe calls.
[Additional Note 5] The system according to Additional Note 1, wherein the ringing unit is configured to sound a ringtone only when the call is a safe call.
[Additional Note 6] The system according to Additional Note 1, wherein the analysis unit is configured to estimate the user's emotion when analyzing the content of the telephone call, and adjust the analysis accuracy based on the estimated user emotion.
[Additional Note 7] The system according to Additional Note 1, wherein the analysis unit is configured to support different languages and dialects when converting the content of the telephone call into text using speech recognition technology.
[Additional Note 8] The system according to Additional Note 1, wherein the analysis unit is configured to remove background sounds and noise when analyzing the content of the telephone call to improve analysis accuracy.
[Additional Note 9] The system according to Additional Note 1, wherein the analysis unit is configured to estimate the user's emotion when analyzing the content of the telephone call, and adjust the display method of the analysis result based on the estimated user emotion.
[Additional Note 10] The system according to Additional Note 1, wherein the analysis unit is configured to highlight specific keywords or phrases when converting the content of the telephone call into text using speech recognition technology.
[Additional Note 11] The system according to Additional Note 1, wherein the analysis unit is configured to refer to past call history when analyzing the content of the telephone call to improve analysis accuracy.
[Additional Note 12] The system according to Additional Note 1, wherein the determination unit is configured to estimate the user's emotion and adjust the criteria for determining whether the call is a safe call based on the estimated user emotion.
[Additional Note 13] The system according to Additional Note 1, wherein the determination unit is configured to refer to call history and contact lists to improve the accuracy of determining that calls from family members or friends are safe calls.
[Additional Note 14] The system according to Additional Note 1, wherein the determination unit is configured to refer to the latest information on fraud schemes to update the determination criteria when determining that calls containing keywords indicative of possible fraud are not safe calls.
[Additional Note 15] The system according to Additional Note 1, wherein the determination unit is configured to estimate the user's emotion and adjust the notification method of the determination result based on the estimated user emotion.
[Additional Note 16] The system according to Additional Note 1, wherein the determination unit is configured to consider the frequency and time of calls to improve the accuracy of determining that calls from family members or friends are safe calls.
[Additional Note 17] The system according to Additional Note 1, wherein the determination unit is configured to consider not only the content of the call but also the caller information when determining that calls containing keywords indicative of possible fraud are not safe calls.
[Additional Note 18] The system according to Additional Note 1, wherein the ringing unit is configured to estimate the user's emotion and adjust the type and volume of the ringtone based on the estimated user emotion.
[Additional Note 19] The system according to Additional Note 1, wherein the ringing unit is configured to adjust the ringing timing by considering the user's schedule and activity status when sounding the ringtone only for safe calls.
[Additional Note 20] The system according to Additional Note 1, wherein the ringing unit is configured to provide customizable ringtones according to the user's preferences when sounding the ringtone.
[Additional Note 21] The system according to Additional Note 1, wherein the ringing unit is configured to estimate the user's emotion and adjust the ringing duration of the ringtone based on the estimated user emotion.
[Additional Note 22] The system according to Additional Note 1, wherein the ringing unit is configured to set the optimal volume by considering the user's device settings and ambient sounds when sounding the ringtone only for safe calls.
[Additional Note 23] The system according to Additional Note 1, wherein the ringing unit is configured to refer to the user's past response history to adjust the ringing pattern when sounding the ringtone.

What is claimed is:

1. A system comprising: an analysis unit configured to analyze the content of a telephone call; a determination unit configured to determine, based on the content analyzed by the analysis unit, whether the call is a safe call; and a ringing unit configured to sound a ringtone when the determination unit determines that the call is a safe call.

2. The system according to claim 1, wherein the analysis unit is configured to convert the content of the telephone call into text using speech recognition technology.

3. The system according to claim 1, wherein the determination unit is configured to determine that calls from family members or friends are safe calls.

4. The system according to claim 1, wherein the determination unit is configured to determine that calls containing keywords indicative of possible fraud are not safe calls.

5. The system according to claim 1, wherein the ringing unit is configured to sound a ringtone only when the call is a safe call.

6. The system according to claim 1, wherein the analysis unit is configured to estimate the user's emotion when analyzing the content of the telephone call, and adjust the analysis accuracy based on the estimated user emotion.

7. The system according to claim 1, wherein the analysis unit is configured to support different languages and dialects when converting the content of the telephone call into text using speech recognition technology.

8. The system according to claim 1, wherein the analysis unit is configured to remove background sounds and noise when analyzing the content of the telephone call to improve analysis accuracy.

9. The system according to claim 1, wherein the analysis unit is configured to estimate the user's emotion when analyzing the content of the telephone call, and adjust the display method of the analysis result based on the estimated user emotion.

10. The system according to claim 1, wherein the analysis unit is configured to highlight specific keywords or phrases when converting the content of the telephone call into text using speech recognition technology.
